(19) United States
(12) Patent Application Publication
(10) Pub. No.: US 2006/0026343 A1
(43) Pub. Date: Feb. 2, 2006

(54) Data buffering method in disc data reading system and system of the same

(76) Inventors: Sung Yang Wu, Daya Township (TW); Ming Hung Lee, Yonghe City (TW)

Correspondence Address: Hoffman, Warnick & D'Alessandro LLC, 14th Floor, 75 State Street, Albany, NY, 12207, US

(21) Appl. No.: 11/191,510

(22) Filed: Jul. 28, 2005

(30) Foreign Application Priority Data
Jul. 30, 2004 (TW) 093123027

(51) Int. Cl. G06F 12/00

(52) U.S. Cl. 711/112

(57) ABSTRACT

The present invention relates to a data buffering method, and more particularly, relates to a data buffering method in a disc data reading system. According to the request of instructions, the disc data reading system reads disc data into a data buffer apparatus for later accessing and processing. In the data buffering method, according to a transmitted request of a first instruction, the data is read from the disc data reading system and is then buffered into the first area selected by the data buffer apparatus. According to a transmitted request of a second instruction, the data is read from the disc and is then buffered into the second area selected by the data buffer apparatus. The first area and the second area are located in different and non-overlapped areas inside the data buffer apparatus, so that the data in the first area will not be over-written during the process of data buffering in the second area. Those data in the data buffer apparatus could be read out directly for later issued instructions.

### BACKGROUND OF THE INVENTION

1. Field of the Invention

The present invention relates to a data buffering method, and more particularly, the present invention relates to a data buffering method in a disc data reading system.

2. Description of the Related Art

A disc data reading system of the related art can buffer disc data into a selected area of a data buffer apparatus, according the request of an instruction, for further accessing and processing.

In the data buffering method of the related art, when new data is written into a selected area of a data buffer apparatus, the previous data buffered in the same area is over-written or deleted. If the same previous data is to be read later, the requested data has to be read out from the disc again. Because mechanical movements are involved to read out the requested data from the disc data reading system, the access time of the system is longer, and the efficiency of data accessing is reduced.

In the data buffering method of the related art, when a host sends command to read out data between two or more points from the disc, the drive will move the optical pickup head between those points. Since data needs to be read out data repeatedly from the disc, the mechanic movements take lots of precious time and cause the entire processing time of the system to slow down. Therefore, improving the data buffering method to save data processing time has become more and more important.

### SUMMARY OF THE INVENTION

An objective of the present invention is to provide a data buffering method for solving problems mentioned above, that is, the data processing time is slowed down when data is read out from the disc repetitiously.

Based upon one embodiment of the present invention, the data buffering method used in a disc data reading system stores data into a data buffer apparatus for further accessing and processing according to the requests of a plurality of instructions.

The data buffering method of the present invention, according to the request of a first instruction, reads out the data requested by the first instruction from the disc, and buffers the data into a first area selected by the data buffer apparatus. The data buffering method of the present invention, according to the request of a second instruction, reads out the data requested by the second instruction from the disc, and buffers the data into a second area selected by the data buffer apparatus.

The first area and the second area are located in different and non-overlapping areas of the data buffer apparatus, so that the data earlier stored in the first area won't be over-written when the data are buffered into the second area. When a new instruction is received, the disc data reading system will first check whether the data requested by the new instruction has already been buffered into the data buffer apparatus or not; if YES, the requested data is directly outputted from the data buffer apparatus without having to read out the requested data from the disc data reading system again.

Therefore, the present invention saves the data reading time to further decrease the data accessing time and to improve performance of the disc data reading system.

The advantage and spirit of the invention may be understood by the following recitations together with the appended drawings.

### BRIEF DESCRIPTION OF THE APPENDED DRAWINGS

FIG. 1 is a schematic diagram showing the data buffering method of the present invention.

FIG. 2 is a schematic diagram showing the data buffering system of the present invention.

FIG. 3 is a schematic diagram showing a recording list of the data buffering method of the present invention.

FIG. 4 is a flow chart showing the data buffering method of the present invention.

FIG. 5 is an embodiment of the data buffering system of the present invention.

### DETAILED DESCRIPTION OF THE INVENTION

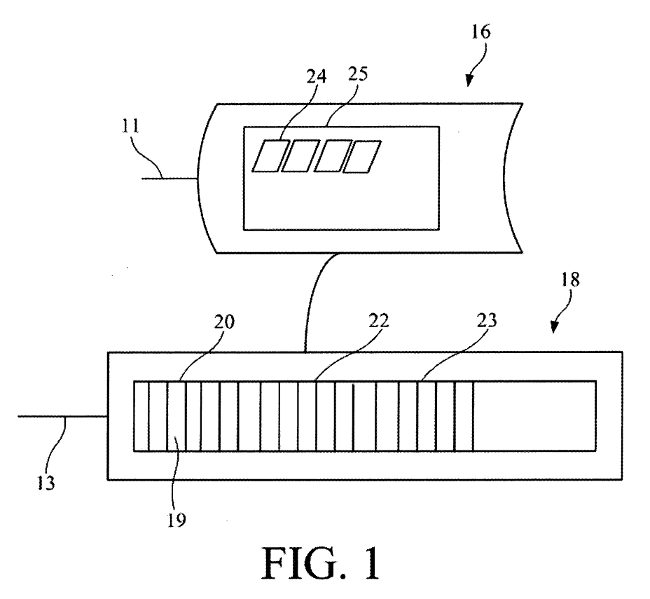

Referring to FIG. 1, FIG. 1 is a schematic diagram showing the disc data reading system 16 of the present invention. The disc data reading system 16 temporarily stores data into a data buffer apparatus 18 for further accessing and processing according to the request of a plurality of received instructions. The disc data reading system 16 comprises an instruction receiving terminal 11; and the data buffer apparatus 18 comprises a data output terminal 13.

The disc data reading system 16 comprises a disc storage apparatus 25 which further comprises a plurality of data sectors 24 for storing the data requested by the instructions. The disc storage apparatus 25 utilizes corresponding data addresses to indicate the positions of the data stored in the disc storage apparatus 25.

Referring to FIG. 1, the data buffer apparatus 18 comprises a plurality of areas formed by a plurality of data slots 19; theses areas are located in different and non-overlapping areas of the data buffer apparatus 18. As shown in FIG. 1, there are a first data sector 20, a second data sector 22, a third data sector 23, wherein the position of the second data sector 22 follows right after the position of the first data sector 20 in the data buffer apparatus 18, and the position of the third data sector 23 follows right after the position of the second data sector 22. The data read out from the data sector 24 of the disc storage apparatus 25 is buffered into the fourth data sector of the data slots 19.

In one embodiment, the disc data reading system 16 reads out data according to the requests of at least a first instruction and a second instruction and buffers the data requested by the first instruction and the second instruction respectively into a selected first data sector 20 and a selected second data sector 22 in the data buffer apparatus 18. The first data sector 20 and the second data sector 22 are located in the different and non-overlapping areas of the data buffer apparatus 18, so that the data in the first data sector 20 will not be over-written while the data are buffered into the second sector 22.

When a new instruction is received, the requested disc data will be checked if the related data sector is already in the data buffer apparatus 18. If the disc data requested by the new instruction is not in the buffer apparatus 18, it will be read out from the disc data reading system 16 and will be buffered into the data buffer apparatus 18 without over-writing previous data already in the data buffer apparatus 18. In this embodiment, the data requested by the new instruction are buffered into the third data sector 23.

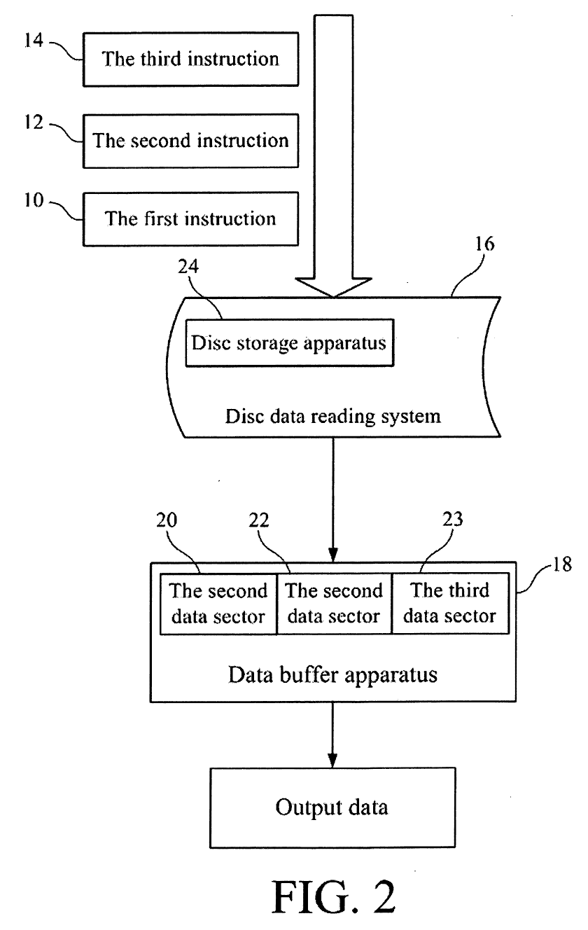

Referring to FIG. 2, FIG. 2 is a schematic diagram showing a data buffering system of the present invention. In another embodiment, the data buffering method of the present invention is utilized in the disc data reading system 16 for temporarily storing data into a data buffer apparatus 18 for further accessing and processing according to the requests of the plurality of instructions. The disc data requested by the instructions are stored in a plurality of data sectors 24 of a disc storage apparatus 25. The data being read out from the data sectors 24 are then buffered into a plurality of data slots 19 of the data buffer apparatus 18. In this embodiment, the received instructions are respectively a first instruction 10, a second instruction 12, and a third instruction 14.

The data buffering method of the present invention is described in detail below. According to the request of the first instruction 10, the data requested by the first instruction 10 are read out from the disc data reading system 16 and are buffered into the first area 20 selected by the data buffer apparatus 18. Afterward, according to the request of the second instruction 12, the data requested by the second instruction 12 are read out from the disc data reading system 16 and are buffered into the second area 22 selected by the data buffer apparatus 18. Because the first area 20 and the second area 22 are located in different and non-overlapped areas of the data buffer apparatus 18, the data in the first area 20 are not being over-written when the data are buffered into the second area 22.

When a new instruction, the third instruction 14, is received, the disc data requested by the third instruction 14 are read out from the disc data reading system 16 and are buffered into the data buffer apparatus 18 without over-writing previous data already in the data buffer apparatus 18.

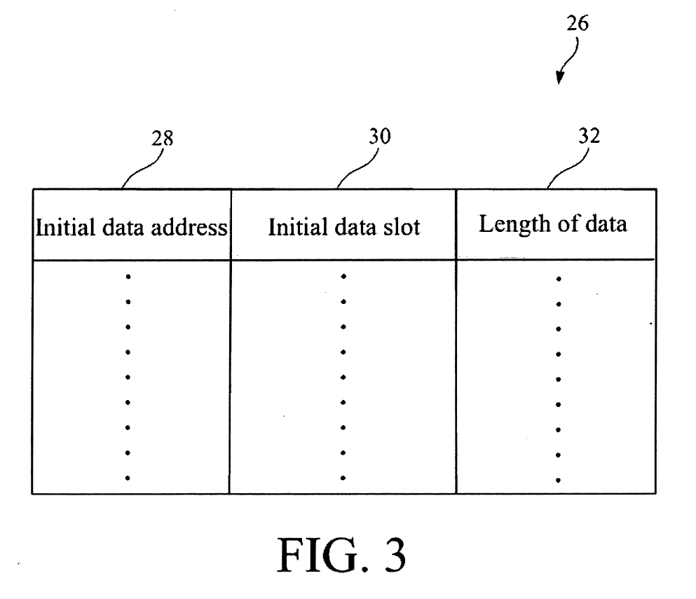

Referring to FIG. 3, FIG. 3 is a schematic diagram showing a recording list 26 of the data buffering method of the present invention. In the data buffering method of the present invention, the recording list 26 comprises a plurality of recording fields which is employed to keep track of the buffer information of each data. The buffer information comprises information of an initial data address 28 of the data in the disc storage apparatus, information of an initial data slot 30 of the data in the data buffer apparatus, and information of the length 32 of the data. In FIG. 3, the fields 28, 30, and 32 are utilized to respectively store the above-mentioned initial data address, the initial data slot, and the length of the data.

When a new instruction, the third instruction 14, is received, the buffer information of the previous instruction, the second instruction 12, is updated in the recording list 26. Besides, when the third instruction 14 is received, an examination is made to check whether the data requested by the third instruction 14 have already been buffered into the data buffer apparatus 18 by previous instructions 10 or 12 or not. If YES, the requested data is directly outputted from the data buffer apparatus 18 without having to read out the requested data from the disc data reading system 16 again.

In the data buffering method of the present invention, if the data requested by the new instruction, the third instruction 14, have not been buffered into the data buffer apparatus 18 by the previous instructions, a default data preserving procedure is further employed to preserve the temporary data of the previous instruction, the second instruction 12; afterwards, the buffer information of the data of the previous instruction, the second instruction 12, is updated in the recording list 26. Finally, the next empty data area in the data buffer apparatus 18 is identified for buffering the data in the disc storage apparatus 25 into the data slots of the empty data area. The default data preserving procedure sets a maximal number (N) of the data sectors for the data to be preserved, and it buffers only the data of the last N data sectors of the temporary data. For example, if N is pre-set to be 32, when the length of data is more than 32, the system preserves only the data of the last 32 data sectors of the temporary data, and the rest of the data is deleted to keep the capacity of the data buffer apparatus 18 under control.

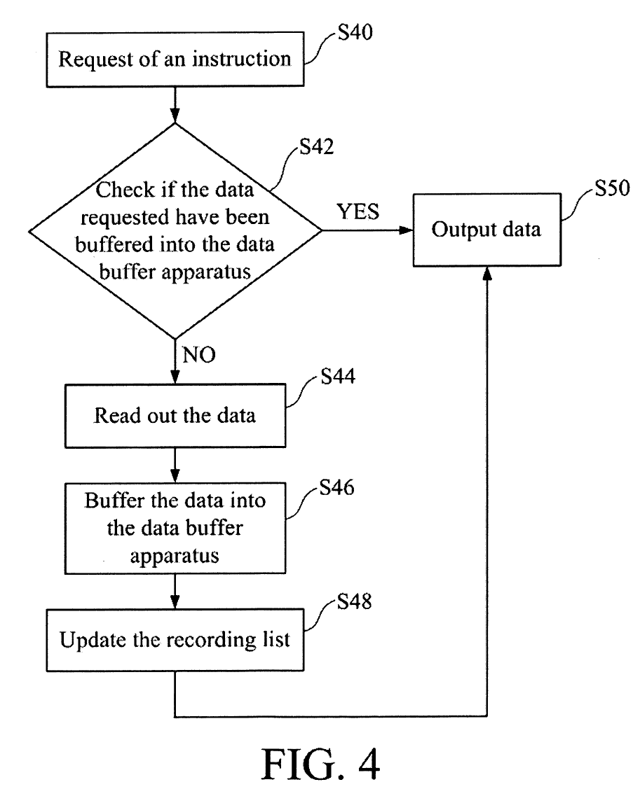

Referring to FIG. 4, FIG. 4 is a flow chart showing the data buffering method of the present invention, which comprises the steps of:
S40: Receive the request of a first instruction 10;
S42: Check whether the data requested by the first instruction 10 have been buffered into the data buffer apparatus 18 or not; if YES, then go to S50; if NO, then go to S44;
S44: Read out the data requested by the first instruction 10 from the disc storage apparatus 25;
S46: Buffer the data requested by the first instruction 10 into a first area 20 selected by the data buffer apparatus 18;
S48: Update the recording list 26; if the length of the data requested by the instruction is too large that the data requested by the previous is over-written, the condition will be reflected to the recording list 26;
S50: Output the data;
The data buffer apparatus 18 of the disc data reading system 16 of the present invention can be a dynamic random access memory (DRAM) comprising at least 256 KB. The data buffer apparatus 18 can also be a ring buffer.

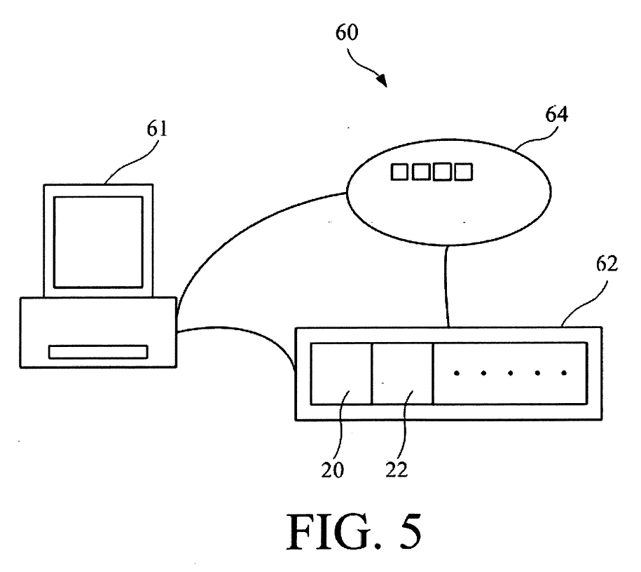

Referring to FIG. 5, FIG. 5 is a schematic diagram of an embodiment of the disc data reading system 60 of the present invention. In the embodiment, the data buffering method of the present invention is employed in the disc data reading system 60. The disc data reading system 60 comprises an optical disc 64, and a dynamic random access memory (DRAM) 62 comprising 256 KB is used for buffering the data read out from the optical disc 64.

When a host 61 transfers the requests of the first instruction 10 and the second instruction 12 for reading the optical disc 64, the data requested by the first instruction 10 and the second instruction 12 are read out from the optical disc 64 and are buffered respectively into the selected first area 20 and the selected second area 22 in the dynamic random access memory 62. Because the first area 20 and the second area 22 are located in the different and non-overlapped areas of the dynamic random access memory 62, the data in the first area 20 are not being over-written when the data are buffered into the second area.

When a new instruction, the third instruction 14, is received, the host 61 checks whether the data requested by the third instruction 14 have already been buffered into the dynamic random access memory 62 or not; if YES, the requested data is directly outputted from the dynamic random access memory 62 without having to read out the requested data from the optical disc 64 again. Therefore, the disc data reading system 60 of the present invention saves the accessing time of the whole system.

Comparing with the related art, in the data buffering method of the present invention, when a new instruction is received, the disc data requested by the new instruction are read out from the disc data reading system and are buffered into the data buffer apparatus without over-writing previous data already in the data buffer apparatus. When a new instruction is received, an examination is made to check whether the data requested by the new instruction have already been buffered into the data buffer apparatus or not; if YES, the requested data is directly outputted from the data buffer apparatus without having to read out the requested data from the disc data reading system again. Therefore, the present invention saves the data reading time to further decrease data accessing time of the whole system.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data buffering method used in a disc data reading system, the disc data reading system reading data into a data buffer apparatus for further accessing according to the request of instructions; the data buffering method comprising the steps of:
according to the request of a first instruction, reading out the data requested by the first instruction from the disc data reading system and buffering the data into a first area selected by the data buffer apparatus; and
according to the request of a second instruction, reading out the data requested by the second instruction from the disc data reading system and buffering the data into a second area selected by the data buffer apparatus;
wherein the first area and the second area are located in different and non-overlapped areas of the data buffer apparatus, so that the data in the first area are not being over-written when the data are buffered into the second area.

2. The data buffering method of claim 1, wherein the position of the second area follows the position of the first area in the data buffer apparatus.

3. The data buffering method of claim 1, wherein when a new instruction is received, the disc data requested by the new instruction are read out from the disc data reading system and are buffered into the data buffer apparatus without over-writing previous data already in the data buffer apparatus.

4. The data buffering method of claim 1, wherein the disc data reading system comprises a disc storage apparatus comprising a plurality of data sectors for storing the data requested by the instruction, and wherein the data storage apparatus utilizes corresponding data addresses to indicate the position of the data in the disc storage apparatus.

5. The data buffering method of claim 4, wherein the data in the data sectors are buffered into a plurality of data slots of the data buffer apparatus.

6. The data buffering method of claim 5, further comprising employing a recording list having a plurality of recording fields to keep track of the buffer information of each data, and wherein the buffer information comprises information of an initial data address of the data in the disc storage apparatus, information of an initial data slot of the data in the data buffer apparatus, and information of the length of the data.

7. The data buffering method of claim 6, wherein only when a new instruction is received, then the buffer information of the previous instruction is updated in the recording list.

8. The data buffering method of claim 7, wherein when the new instruction is received, an examination is made to check whether the data requested by the new instruction have been buffered into the data buffer apparatus or not; if YES, the requested data is directly outputted from the data buffer apparatus without having to read out the requested data from the disc data reading system again.

9. The data buffering method of claim 8, wherein if the data requested by the new instruction have not been buffered into the data buffer apparatus based upon the previous instructions, a default data preserving procedure is further employed to preserve temporary data of the previous instruction; afterward, the buffer information of the data of the previous instruction is updated in the recording list; then, a next empty data area in the data buffer apparatus is identified for buffering the data in the disc storage apparatus into the data slots of the empty data area.

10. The data buffering method of claim 9, wherein the default data preserving procedure sets a maximal number (N) of data sectors for the data to be preserved, and buffers only the data of the last N data sectors of the temporary data.

11. A disc data reading system for reading out data according to requests of at least a first instruction and a second instruction and buffering the data requested by the first instruction and the second instruction respectively into a selected first area and a selected second area in a data buffer apparatus, wherein the first area and the second area are located in the different and non-overlapped areas of the data buffer apparatus, so that the data in the first area are not being over-written when the data are buffered into the second area.

12. The disc data reading system of claim 11, wherein the data buffer apparatus comprises a dynamic random access memory (DRAM) comprising at least 256 KB.

13. The disc data reading system of claim 11, wherein when a new instruction is received, the disc data requested by the new instruction are read out from the disc data reading system and are buffered into the data buffer apparatus without over-writing the previous data already in the data buffer apparatus.

14. The disc data reading system of claim 11, wherein the disc data reading system comprises a disc storage apparatus comprising a plurality of data sectors for storing the data requested by the instruction, and wherein the data storage apparatus utilizes corresponding data addresses to indicate the position of the data in the disc storage apparatus.

15. The disc data reading system of claim 14, wherein the data in the data sector are buffered into a plurality of data slots of the data buffer apparatus.

16. The disc data reading system of claim 15, wherein a recording list comprising a plurality of recording fields is employed to keep track of the buffer information of each data, and wherein the buffer information comprises information of an initial data address of the data in the disc storage apparatus, information of an initial data slot of the data in the data buffer apparatus, and information of the length of the data.

17. The disc data reading system of claim 16, wherein only when a new instruction is received, then the buffer information of the previous instruction is updated in the recording list.

18. The disc data reading system of claim 17, wherein when the new instruction is received, an examination is made to check whether the data requested by the new instruction have been buffered into the data buffer apparatus or not; if YES, the requested data is directly outputted from the data buffer apparatus without having to read out the requested data from the disc data reading system again.

19. The disc data reading system of claim 18, wherein if the data requested by the new instruction have not been buffered into the data buffer apparatus based upon the previous instructions, a default data preserving procedure is further employed to preserve temporary data of the previous instruction; afterward, the buffer information of the data of the previous instruction is updated in the recording list; then, a next empty data area in the data buffer apparatus is identified for buffering the data in the disc storage apparatus into the data slots of the empty data area.

20. The disc data reading system of claim 19, wherein the default data preserving procedure sets a maximal number (N) of data sectors for the data to be reserved, and buffers only the data of the last N data sectors of the temporary data.

21. The disc data reading system of claim 11, wherein the data buffer apparatus comprises a ring buffer.
